(19) United States
(12) Patent Application Publication
(10) Pub. No.: US 2013/0122218 A1
(43) Pub. Date: May 16, 2013

(54) CERAMIC SPRAYED MEMBER, MAKING METHOD, ABRASIVE MEDIUM FOR USE THEREWITH

(71) Applicant: SHIN-ETSU CHEMICAL CO., LTD., Tokyo (JP)

(72) Inventors: Takao MAEDA, Tokyo (JP); Hajime NAKANO, Tokyo (JP); Toshihiko TSUKATANI, Tokyo (JP)

(73) Assignee: SHIN-ETSU CHEMICAL CO., LTD., Tokyo (JP)

(21) Appl. No.: 13/733,086

(22) Filed: Jan. 2, 2013

Related U.S. Application Data
(62) Division of application No. 12/359,116, filed on Jan. 23, 2009.

(30) Foreign Application Priority Data
Jan. 24, 2008 (JP) 2008-013620

(51) Int. Cl. B05D 3/02; B05D 3/12

(52) U.S. Cl. 427/560; 427/331; 427/353; 427/352; 427/355

(57) ABSTRACT

A ceramic sprayed member comprises a substrate and a ceramic sprayed coating thereon. Splats have been removed from the surface of the sprayed coating, typically by blasting. The ceramic sprayed member with improved plasma resistance mitigates particle contamination of wafers and enables stable manufacture when used in a halogen plasma process for semiconductor fabrication or the like.

### CROSS-REFERENCE TO RELATED APPLICATION

This application is a divisional application of U.S. patent application No. 12/359,116, filed Jan. 23, 2009, and claims priority under 35 U.S.C. §119(a) of Japanese Patent Application No. 2008-013620, filed Jan. 24, 2008, the entire contents of which are hereby incorporated by reference.

### TECHNICAL FIELD

This invention relates to surface tailoring of ceramic sprayed coatings, and more particularly, to ceramic sprayed members for use as plasma-resistant members in plasma processing apparatus, typically dry etching apparatus in the semiconductor and flat panel display fabrication industries, and a method for preparing the same. It also relates to abrasive media for use with ceramic sprayed members.

### BACKGROUND ART

As is well known in the art, systems for the fabrication of semiconductor devices and flat panel displays such as liquid crystal displays and organic or inorganic electroluminescent displays often operate in a halogen-based corrosive gas atmosphere. Components of these systems are made of high purity materials in order to protect workpieces from impurity contamination and particle defects. In particular, the surface state and purity of these components are crucial.

Currently, the semiconductor fabrication technology requires to narrow the width of interconnections formed on wafers to facilitate higher integration of devices, which in turn, strongly demands to improve the process precision and the processing environment. As a consequence, yttrium oxide-based sprayed members are widely used as the chamber inner wall because of their high plasma resistance. They aim to improve the processing environment during etching, that is, to mitigate contamination with particles given off during etching process (see U.S. Pat. No. 6,783,863 or JP-A 2001-164354). In fact, Y₂O₃ sprayed coatings have excellent plasma resistance and cost performance. They have been used as chamber inner walls and jigs which are exposed to plasma in semiconductor wafer dry etching process. They have achieved process improvements including improvements in semiconductor device productivity and savings of maintenance expense.

Although the yttrium oxide sprayed members are successful in reducing contamination with newborn particles of aluminum fluoride or the like, another problem becomes highlighted that wafers are contaminated with yttrium.

An attempt has been made to remove a yttrium-contaminated zone by blasting with alumina grains. The blast of alumina alone, however, suffers from such problems as excessive abrasion of members, difficult thickness control due to excessive abrasion, and retention of blasted grains sticking into the surface, which causes surface contamination again.

### DISCLOSURE OF THE INVENTION

The current Y₂O₃ sprayed members adapted to withstand halogen gas plasma have such a basic surface structure that their surface is irregular due to the nature of spraying process. These surface irregularities advantageously play the role of capturing secondary deposits in the etching process. Then the sprayed members are ready for use as deposited, possibly without abrasive finishing.

The surface of a sprayed coating as deposited is composed of sprayed splats (molten particles), unmelted particles, splash particles scattering from splats, and the like. Of these, unmelted particles and splash particles adhere to the surface with so weak forces that they can be partly removed by deionized water ultrasonic washing. However, valleys in sprayed lamellae and overlaps between molten particles from the spraying side (spraying environment) are not amenable to particle removal by deionized water ultrasonic washing.

A close survey of sprayed splats has revealed the following. At tips of sprayed splats, some portions form lamellae weakly adhering to the underlying sprayed lamellae. Microcracks exist in splats of a ceramic or brittle material. At splat tips, there are left a number of portions containing microcracks and weakly adhering to the underlying. These portions are also not removed by initial deionized water ultrasonic washing. It is then expected that after the member is installed in a plasma processing apparatus, cracks grow and propagate from microcracks during plasma treatment, and tip portions cease to be part of the film and leave as free particles.

It is pointed out in the art that sprayed members release particles at the initial of their use. Prior to operation of an apparatus having a sprayed member built therein, a dummy run is performed using a dummy wafer, wherein the dummy wafer serves to reduce particles released from the sprayed member. It is known that as the number of dummy runs increases, the number of particles decreases. The mechanisms include the effect of the dummy wafer adsorbing released particles and the effect of the particle-releasing area being reduced by surface coverage of secondary deposits. It has not been believed that particles become detrimental in practice.

Currently there is an increasing demand for higher performance devices. For instance, the interconnection pitch reaches as narrow as several tens of nanometers, with which the particle and contamination management levels employed in the prior art are found incompatible. This raises a problem.

Since most particles have a particle size equal to or less than 0.1 μm, the measurement limit of the current technology fails to discriminate whether contamination is caused by particles or ions. This raises another problem.

Moreover, to achieve a further reduction of production cost of the semiconductor fabrication process, the initial run using dummy wafers is required to reduce the running time and the number of wafers.

An object of the invention is to provide ceramic sprayed members with improved plasma resistance, which cause only a minimal level of contamination to wafers and ensure stable manufacture when used in a halogen plasma process for semiconductor fabrication or the like; a method for preparing the same; and an abrasive medium for use with ceramic sprayed members.

Making efforts for the purpose of mitigating wafer contamination, the inventors have found that use of a halogen plasma corrosion resistant member having a sprayed coating from which a potential particulate contamination source has been removed, that is, a sprayed coating from which splats on its surface have been removed is effective in reducing an amount of initially released particles.

Specifically, those particulates considered to be a potential particle contamination source including splats inherently formed on the surface of a sprayed coating, splash particles derived from splats, and adhered unmelted particles are removed by a surface impact spallation technique using a medium having an abrasive embedded in an elastomeric matrix such as rubber or resin. This is followed by washing such as deionized water jet washing, chemical liquid washing, deionized water ultrasonic washing, or dry ice washing. Then a halogen plasma corrosion resistant member is obtained.

Accordingly, one embodiment of the invention is a ceramic sprayed member comprising a substrate and a ceramic sprayed coating thereon having a surface from which splats have been removed.

The ceramic is typically selected from the group consisting of alumina, YAG, zirconia, yttrium oxide, scandium oxide, lanthanoid oxides, yttrium fluoride, scandium fluoride, lanthanoid fluorides, and composite compounds comprising at least one of the foregoing. Most often, the ceramic sprayed member is disposed within a plasma processing apparatus.

Another embodiment of the invention is a method for preparing a ceramic sprayed member, comprising the steps of spraying a ceramic material onto a substrate to form a sprayed coating, and removing splats from a surface of the sprayed coating.

The step of removing splats may include blasting a medium having an abrasive embedded in a rubber or resin matrix to the surface of the sprayed coating. The abrasive is preferably selected from the group consisting of alumina, silicon carbide, silica, ceria and diamond. The step of removing splats may further include washing the blasted surface of the sprayed coating, the washing step being selected from the group consisting of jet water washing, chemical liquid washing, deionized water ultrasonic washing, dry ice washing, and a combination thereof. The ceramic material may be the same as in the one embodiment. Most often, the substrate subject to ceramic spraying is a member to be disposed within a plasma processing apparatus.

A further embodiment of the invention is an abrasive medium for use with ceramic sprayed members, comprising an abrasive embedded in a rubber or resin matrix, the abrasive being selected from the group consisting of alumina, silicon carbide, silica, ceria and diamond.

### BENEFITS OF THE INVENTION

The ceramic sprayed member with improved plasma resistance mitigates particle contamination of wafers and enables stable manufacture when used in a halogen plasma process for semiconductor fabrication or the like.

### BRIEF DESCRIPTION OF THE DRAWINGS

FIG. 1 schematically illustrates a spraying process, indicating lamellar deposition.

FIG. 2 is a photomicrograph of sprayed coating surface.

FIG. 3 is an enlarged photomicrograph of sprayed coating surface.

FIG. 4 is a photomicrograph of sprayed coating surface, showing unstably overlapped splats and a fragment shed by ultrasonic washing.

FIG. 5 is a photomicrograph of sprayed coating surface prior to blasting.

FIG. 6 is a photomicrograph of sprayed coating surface after blasting.

FIG. 7 is a surface roughness curve of blasted coating in Example 1.

FIG. 8 is a surface roughness curve of non-blasted coating in Comparative Example 1.

### DESCRIPTION OF THE PREFERRED EMBODIMENT

According to the invention, a ceramic material is sprayed onto a surface of a substrate to form a ceramic sprayed coating. Any substrates that are subject to spraying may be used. Suitable substrates include metal and ceramic materials, and are typically members of such material to be disposed in plasma processing apparatus, specifically members formed of aluminum, aluminide, stainless steel, alumina, aluminum nitride, silicon nitride, quartz, and carbon.

The ceramic material to be sprayed is typically selected from alumina, yttrium-aluminum garnet (YAG), zirconia, yttrium oxide, scandium oxide, lanthanoid oxides, yttrium fluoride, scandium fluoride, lanthanoid fluorides, and composite compounds comprising at least one of the foregoing. The ceramic sprayed coating may have a thickness of 20 to 500 μm, and more specifically 50 to 300 μm.

Spraying may be performed by any of well-known thermal spraying techniques including plasma spraying and under well-known conditions.

On the ceramic sprayed coating thus formed, there are splats, splash particles scattering therefrom, adhered unmelted particles and the like, which should be removed according to the invention. Removal of splats is effectively carried out by blasting to the surface of the sprayed coating an elastomeric medium having an abrasive embedded in an elastomeric matrix such as rubber or resin, which is also referred to as “abrasive medium for use with ceramic sprayed members” that is another embodiment of the invention.

The elastomeric medium is blasted under a pressure of 0.05 to 0.8 MPa, which may be regulated by the pressure of compressed air. In some cases, an inert gas such as nitrogen or argon may be used instead of the compressed air. With respect to the blast pressure, a reduction of process time is expectable from a higher pressure because of an accelerated process rate, whereas a lower pressure is desirable when fine adjustment of coating thickness is necessary. Accordingly, a pressure of 0.1 to 0.4 MPa is preferable for high-precision, brief, stable blasting. Examples of the elastomeric matrix in which abrasive grains are embedded include rubbers such as natural rubber (NR), isopropylene rubber (IR), styrene-butadiene rubber (SBR), butyl rubber (IIR), butadiene rubber (BR), ethylene-propylene-diene rubber (EPDM), NBR, urethane rubber (U), silicone rubber (Q), fluoro-rubber (FKM), and acrylic rubber (ACM), and resins such as polyethylene, polypropylene, nylon, acrylic resins, fluoro-resins, polyurethane, phenolic resins, and epoxy resins. The abrasive is typically selected from among alumina, silicon carbide, silica, ceria and diamond, all in fine particulate form, and preferably alumina, silicon carbide, and diamond. The content of abrasive grains in the elastomeric matrix may be 5 to 80% by volume of the medium.

In the abrasive medium, the elastomeric matrix is typically a rubber or resin as mentioned above and is preferably free of alkali metals, alkaline earth metals and transition metals which are generally unwanted in the semiconductor fabrication field. The abrasive is typically a material as mentioned above, and preferably has an average grain size equal to or more than #60 mesh. A particle size equal to or more than #300 mesh is more preferable in order to abrade the ceramic sprayed coating on the substrate to a uniform thickness at a high precision. The average grain size is up to #20000, especially up to #10000, although the lower limit is not critical. The abrasive medium is in the form of particles preferably having an average particle size of about 100 μm to about 1 mm.

After blasting of the elastomeric medium, the (blasted) surface of the sprayed coating is preferably washed or cleaned. Washing may be performed by any well-known washing techniques, for example, jet water washing, chemical liquid (e.g., nitric acid) washing, deionized water ultrasonic washing, dry ice washing, and a combination comprising at least one of the foregoing. The washing step removes the medium left on the coating surface after blasting and splat fragments disintegrated by blasting.

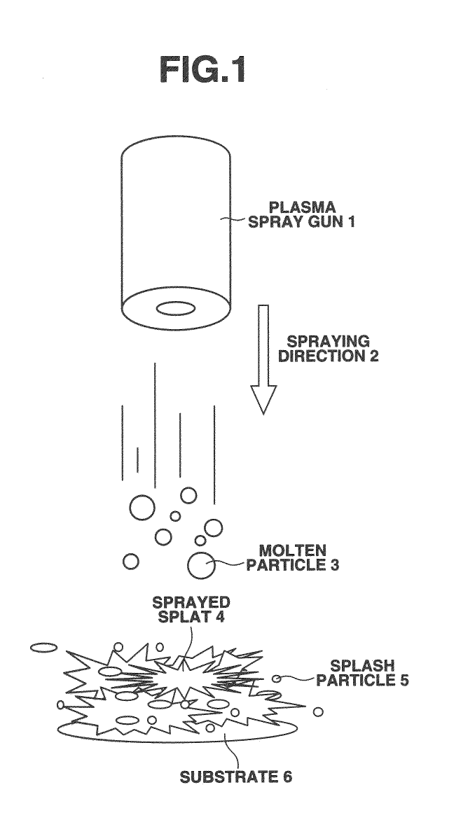

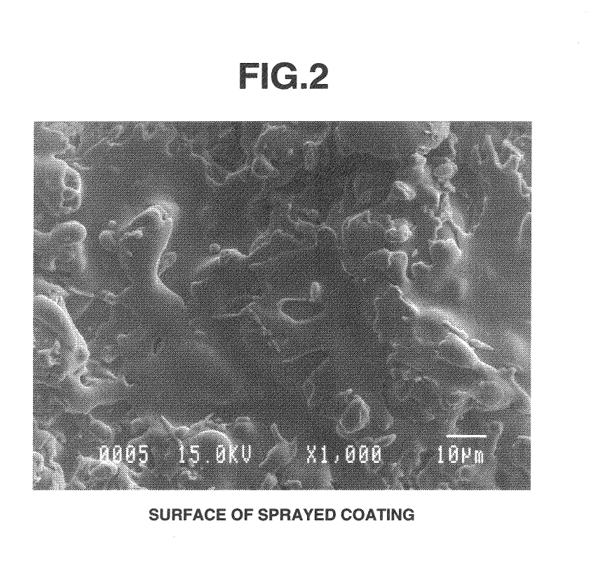

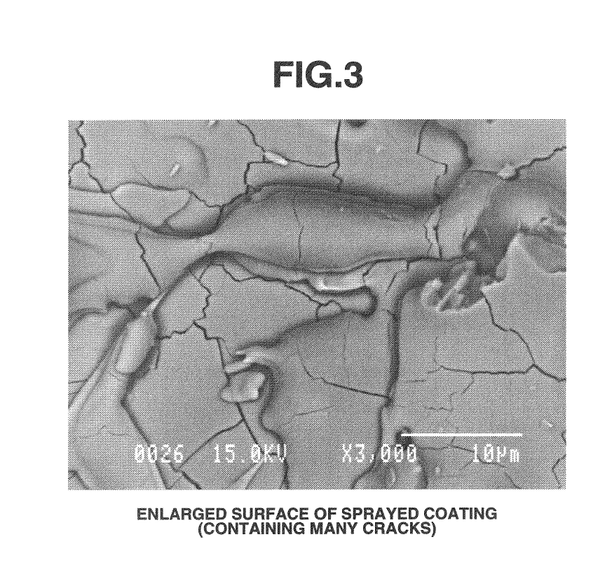

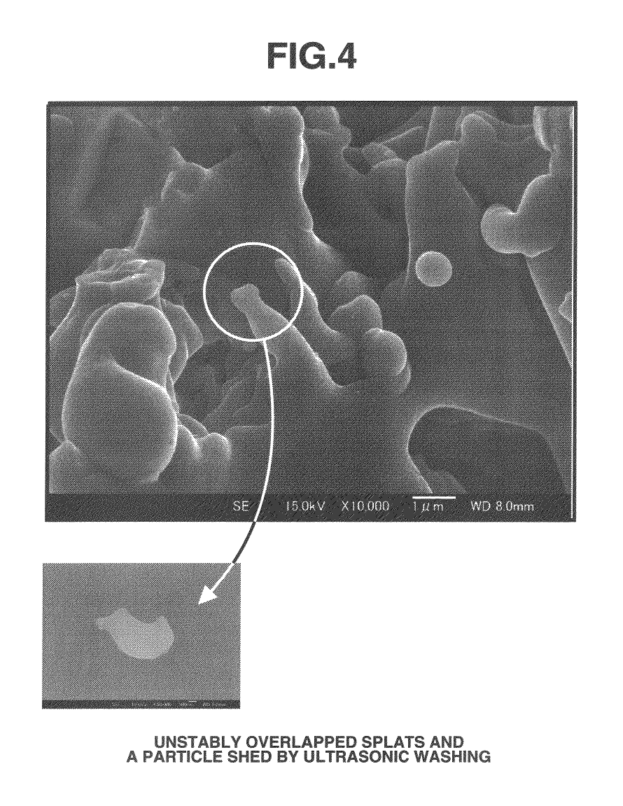

FIG. 1 schematically illustrates a spraying process, indicating lamellar deposition. A plasma spraying gun 1 melts and injects a spray of molten particles 3 in a direction 2 toward a substrate 6. The molten particles 3 impinge substrate 6 to form sprayed splats 4, from which splash particles (or droplets) 5 scatter. FIG. 2 is a photomicrograph of the surface of a sprayed coating. In FIG. 2, splash particles are seen on the surface of a sprayed coating as deposited. FIG. 3 is an enlarged photomicrograph of the surface, where sprayed splats are observed to contain many microcracks. FIG. 4 is a photomicrograph of sprayed coating surface, showing unstably overlapped splats, together with a photomicrograph of a fragment (or particle) which is obtained by ultrasonic washing the sprayed member with deionized water, taking a sample from the wash liquid, drying the sample on a silicon wafer, and observing under an electron microscope. It is seen that the fragment has a similar shape to splash particles resulting from spraying.

According to the invention, those splash particles and splats weakly adhering to the sprayed coating surface are knocked off by a blast of particulate rubber or resin medium with alumina, SiC or diamond abrasive embedded therein having a particle size of about 0.3 to 2 mm impinging against the sprayed coating surface. Only strongly adhering portions are left on the surface. Since a number of fine particles are produced by blasting impingement, they are removed by precision washing, for example, jet water washing, chemical liquid washing, deionized water ultrasonic washing, or CO₂ blast washing, for cleaning the surface. The resultant spray coated member bearing few particles or contaminants is ready for use.

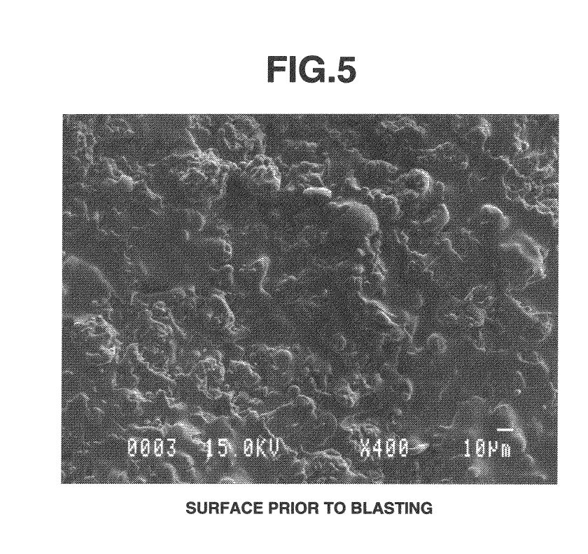

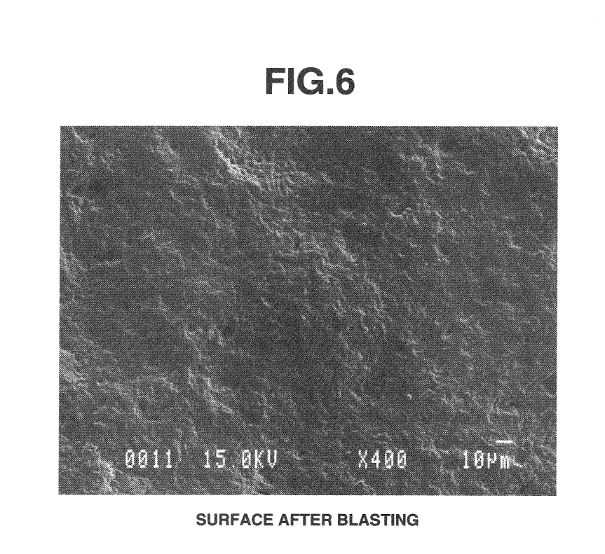

FIGS. 5 and 6 are photomicrographs of the sprayed coating surface prior to and after blasting.

### EXAMPLE

Examples of the invention are given below by way of illustration and not by way of limitation.

### Example 1

A surface of an aluminum alloy substrate of 100 mm square was degreased with acetone and roughened with corundum abrasive. Yttrium oxide powder was sprayed onto the roughened surface by means of an atmospheric plasma spray apparatus, using argon gas as the plasma gas, a power of 40 kW, a spray distance of 100 mm, and a deposition rate of 30 μm/pass. A yttrium oxide coating of 250 μm thick was deposited.

The surface of the sprayed coating was then abraded by blasting an elastomeric medium containing 50% by volume of #1500 SiC (GC) abrasive grains in ethylene-propylene-diene rubber (EPDM) having an average particle size of about 500 μm for 10 minutes. A sample having a coating of 220 μm thick was obtained.

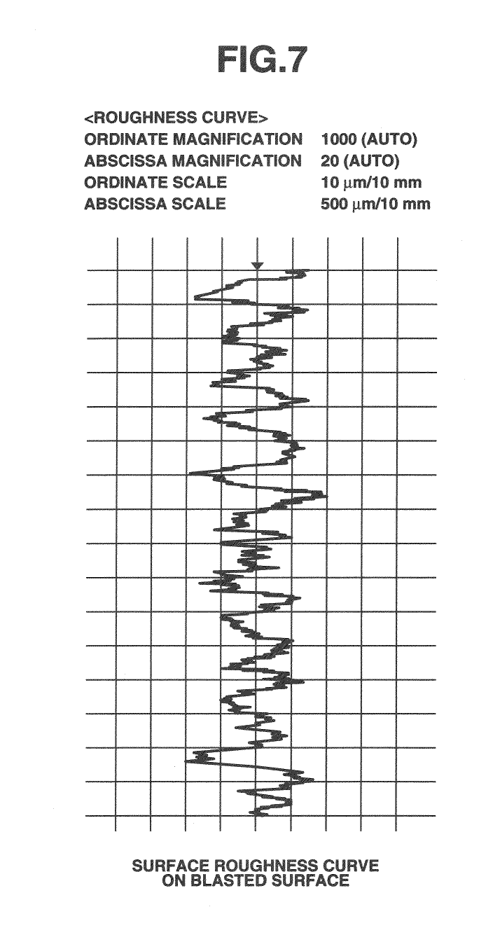

The sample was measured for surface roughness by an instrument Handysurf E-35A (Tokyo Seimitsu Co., Ltd.), with the data plotted as a surface roughness curve in FIG. 7.

### Example 2

A surface of an aluminum alloy substrate of 100 mm square was degreased with acetone and roughened with corundum abrasive. Yttrium fluoride powder was sprayed onto the roughened surface by means of an atmospheric plasma spray apparatus, using argon gas as the plasma gas, a power of 40 kW, a spray distance of 100 mm, and a deposition rate of 30 μm/pass. A yttrium fluoride coating of 250 μm thick was deposited.

The surface of the sprayed coating was blasted with the same elastomeric medium as in Example 1 for 10 minutes. A sample having a coating of 220 gm thick was obtained.

### Example 3

A surface of an aluminum alloy disc having a diameter of 400 mm (serving as a ring-shaped semiconductor etcher member) was degreased with acetone and roughened with corundum abrasive. Yttrium oxide powder was sprayed onto the roughened surface by means of an atmospheric plasma spray apparatus, using argon gas as the plasma gas, a power of 40 kW, a spray distance of 100 mm, and a deposition rate of 30 μm/pass. A yttrium oxide coating of 250 μm thick was deposited.

The surface of the sprayed coating was blasted with the same elastomeric medium as in Example 1 for 30 minutes.

A member having a coating of 220 μm thick was obtained.

### Comparative Example 1

A surface of an aluminum alloy substrate of 100 mm square was degreased with acetone and roughened with corundum abrasive. Yttrium oxide powder was sprayed onto the roughened surface by means of an atmospheric plasma spray apparatus, using argon gas as the plasma gas, a power of 40 W, a spray distance of 100 mm, and a deposition rate of 30 μm/pass. A sample having a yttrium oxide coating of 250 m thick was obtained.

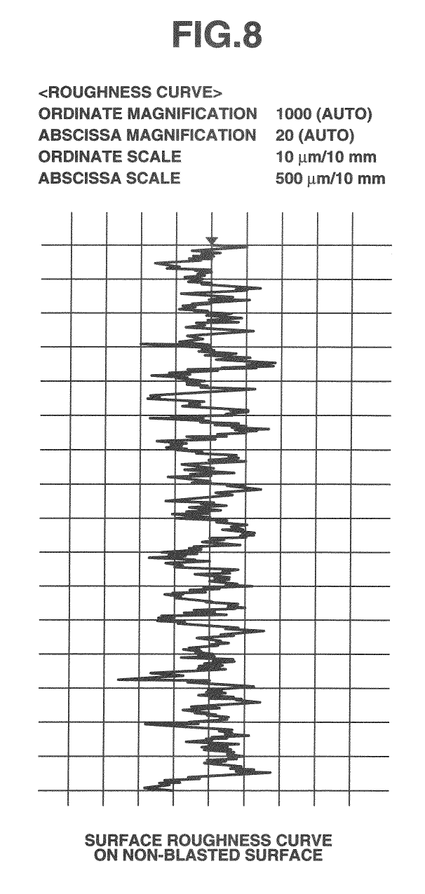

The sample was measured for surface roughness by an instrument Handysurf E-35A (Tokyo Seimitsu Co., Ltd.), with the data plotted as a surface roughness curve in FIG. 8.

### Comparative Example 2

A surface of an aluminum alloy substrate of 100 mm square was degreased with acetone and roughened with corundum abrasive. Yttrium oxide powder was sprayed onto the roughened surface by means of an atmospheric plasma spray apparatus, using argon gas as the plasma gas, a power of 40 kW, a spray distance of 100 mm, and a deposition rate of 30 μm/pass. A yttrium oxide coating of 250 μm thick was deposited.

The surface of the sprayed coating was ground with #1500 GC abrasive paper for 10 minutes, obtaining a sample.

Number of Particles on Sprayed Coating

The sprayed coating of each sample was dry ice blasted, then ultrasonic washed with deionized water, and dried to remove water, after which the number of particles on the sprayed coating surface was counted by a particle counter. Specifically, the number of particles having a size of at least 0.3 μm per square centimeter was counted by a particle counter QIII Plus by Pentagon Technologies. The results are shown in Table 1.

TABLE 1
Number of particles

| | Prior to washing | After washing |
|---|---|---|
| Example 1 | 1233 | <1 |
| Example 2 | 987 | <1 |
| Example 3 | 1064 | <1 |
| Comparative Example 1 | 920 | 9 |
| Comparative Example 2 | 1009 | 6 |

As seen from Table 1, the samples of Examples 1, 2 and 3 having undergone blasting of an elastomeric medium bore fewer particles than those of Comparative Examples 1 and 2. The sample of Comparative Example 2 which was ground with GC abrasive paper bore a reduced number of particles, which is still unsatisfactory.

The member of Example 3 was installed in a plasma processing apparatus where the number of particles on initial wafers was examined, finding a reduced number of particles as compared with a similar sample without blasting.

It has been demonstrated that removal of splats from the surface of a sprayed coating by a blast of elastomeric abrasive medium ensures that the number of particles (which can cause wafer contamination in a halogen plasma process for semiconductor fabrication or the like) on the sprayed coating surface after washing is minimized. Then the plasma process is capable of stable fabrication from the start.

Table 2 shows the roughness values calculated from the data of FIGS. 7 and 8 according to JIS B0601 (1994). For comparison purposes, a cutoff value (λc) of 0.8 and an evaluation length (Ln) of 4 mm were set.

TABLE 2

| | Example 1 | Comparative Example 1 |
|---|---|---|
| Ra | 3.34 μm | 3.16 μm |
| Ry | 16.06 μm | 17.95 μm |
| Rz | 11.79 μm | 12.20 μm |
| Sm | 272.2 μm | 150.3 μm |

The surface roughness data of blasted and non-blasted samples demonstrate a surface transition from a fine periodic raised/depressed surface on the non-blasted sample to a smoothly curved surface on the blasted sample.

Japanese Patent Application No. 2008-013620 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1-3. (canceled)

4. A method for preparing a ceramic sprayed member, comprising spraying a ceramic material onto a substrate to form a sprayed coating, and removing splats from a surface of the sprayed coating.

5. The method of claim 4 wherein the ceramic material is selected from the group consisting of alumina, YAG, zirconia, yttrium oxide, scandium oxide, lanthanoid oxides, yttrium fluoride, scandium fluoride, lanthanoid fluorides, and composite compounds comprising at least one of the foregoing.

6. The method of claim 4 wherein the step of removing splats includes blasting a medium having an abrasive embedded in a rubber or resin matrix to the surface of the sprayed coating.

7. The method of claim 6 wherein the abrasive is selected from the group consisting of alumina, silicon carbide, silica, ceria and diamond.

8. The method of claim 6 wherein the step of removing splats further includes washing the blasted surface of the sprayed coating, the washing step being selected from the group consisting of jet water washing, chemical liquid washing, deionized water ultrasonic washing, dry ice washing, and a combination thereof.

9. The method of claim 4 wherein the substrate subject to ceramic spraying is a member to be disposed within a plasma processing apparatus.

10. (canceled)
